(19) United States
(12) Patent Application Publication
(10) Pub. No.: US 2022/0199046 A1
(43) Pub. Date: Jun. 23, 2022

(54) DISPLAY BACKLIGHT ADJUSTMENT BASED ON VIEWER POSITION

(71) Applicant: Hewlett-Packard Development Company, L.P., Spring, TX (US)

(72) Inventors: Hsing-Hung Hsieh, Taipei City (TW); Alan Man Pan Tam, Spring, TX (US); Dehuei Chen, Taipei City (TW)

(73) Assignee: Hewlett-Packard Development Company, L.P., Spring, TX (US)

(21) Appl. No.: 17/419,254

(22) PCT Filed: Sep. 6, 2019
(86) PCT No.: PCT/US2019/050096

§ 371 Date: Jun. 28, 2021

(51) Int. Cl. G09G 3/34

(52) U.S. Cl. CPC G09G 3/3426; G09G 2320/0233; G09G 2354/00

(57) ABSTRACT

Example systems and related methods for adjusting a backlight of a display based on a position of a viewer are disclosed. In an example, the system includes a display including an outer surface, and a backlight assembly to emit light in a direction that is perpendicular to the outer surface. In addition, the system includes a controller coupled to the backlight. The controller to adjust a brightness of light emitted from a first portion of the backlight assembly relative to a brightness of light emitted from a second portion of the backlight assembly to provide a substantially uniform brightness for the display at a position of the viewer relative to the display.

### BACKGROUND

Electronic displays may include a backlight assembly that is to emit light that is then passed through the other layers of the display and eventually to the eyes of a viewer or viewers. Some backlight assemblies may include a light guide or other suitable structure that is to guide or direct light generated within the backlight assembly in a direction that is generally perpendicular or normal to an outer surface of the display.

### BRIEF DESCRIPTION OF THE DRAWINGS

Various examples will be described below referring to the following figures:

FIG. 1 is a front view of an electronic device including a display according to some examples;

FIG. 2 is a side view of an electronic device including a display according to some examples;

FIG. 3 is a schematic cross-sectional view of a display according to some examples;

FIG. 4 is a schematic view of a system for adjusting a backlight assembly of a display based on a position of a viewer according to some examples;

FIGS. 5-7 are schematic views of a display and corresponding brightness curves across a lateral direction of the display according to some examples;

FIG. 8 is a schematic view of a system for adjusting a backlight assembly of a display based on a position of a viewer according to some examples; and

FIG. 9 is a flow chart of a method for adjusting a backlight assembly of a display based on a position of a viewer according to some examples

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to. . . .” Also, the term “couple” or “couples” is intended to be broad enough to encompass both indirect and direct connections. Thus, if a first device couples to a second device, that connection may be through a direct connection or through an indirect connection via other devices, components, and connections.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the term “electronic device,” refers to an electronic device that is to carry out machine readable instructions, and may include internal components, such as, processors, power sources, memory devices, etc. For example, an electronic device may include, among other things, a personal computer, a smart phone, a tablet computer, a laptop computer, a personal data assistant, etc. As used herein, the term “display” refers to an electronic display (e.g., a liquid crystal display (LCD), a plasma display, etc.) that is to display images generated by an associated electronic device.

As previously described, the backlight assemblies of some displays may direct light in a direction that is generally perpendicular or normal to an outer surface of the display. This sort of light emission may be referred to as “collimated light,” and it may provide for enhanced brightness for viewers who are disposed directly in front of the display. However, collimated light emission may also cause portions of the display to appear darker as the viewing angle from the viewer to these portions of the display increase. For instance, if a viewer shifts position laterally relative to a center (e.g., a horizontal center) of the display, the far edge of the display to the viewer may become noticeably darker than the near edge. Accordingly, examples disclosed herein include systems (and associated methods) for adjusting light emitted from a backlight assembly of an electronic display so as to provide a substantially uniform brightness of light emitted from the display at the particular position of the viewer. In some examples, the viewer's position relative to the display may be detected, monitored, etc., so as to determine how to adjust the brightness from different portions of the backlight assembly and therefore achieve and maintain a substantially uniform brightness at the position of the viewer during operations.

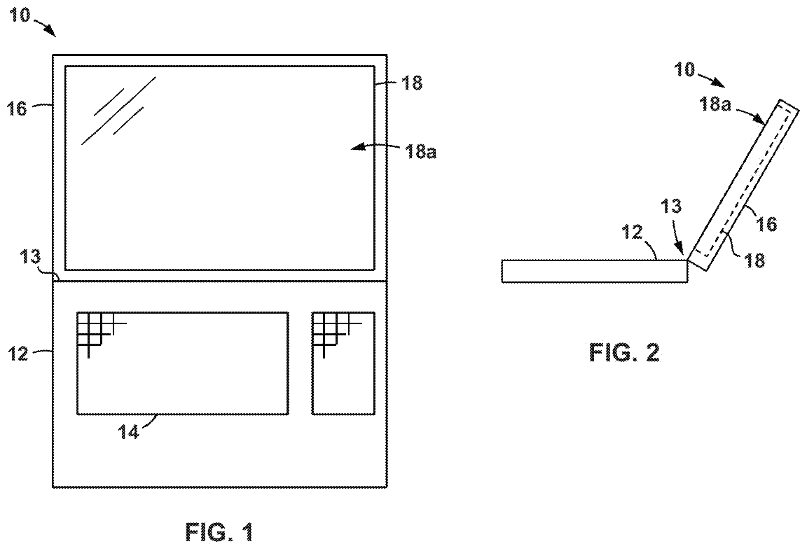

Referring now to FIGS. 1 and 2, an electronic device 10 according to some examples is shown. In this example, electronic device 10 is a laptop computer that includes a first housing member 12 rotatably coupled to a second housing member 16 at a hinge 13. The first housing member 12 includes a user input device, such as, for example, a keyboard 14. The second housing member 16 includes display 18 that is to project images out of a front or outer surface 18a for viewing by a user (not shown) of the electronic device 10.

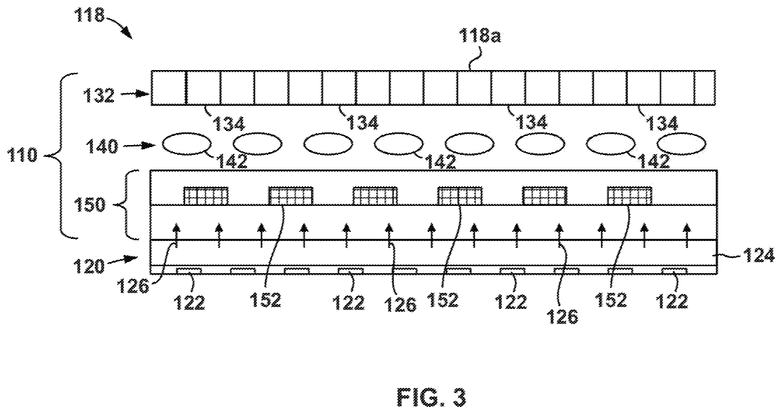

Referring now to FIG. 3, a schematic cross-section of a display 118 is shown. In some examples, the display 118 may be used as the display 18 within electronic device 10, previously described. However, it should be appreciated that the display 118 of FIG. 3 may be utilized within other types of electronic devices (e.g., other than the electronic device 10 of FIGS. 1 and 2), and may, in some examples, be utilized as a standalone display (e.g., such as a television display, computer monitor, etc.). Display 118 includes a backlight assembly 120, and an image generator 110.

In this example, image generator 110 comprises a liquid crystal display panel that includes a color filter 132, a liquid crystal layer 140, and a thin-film transistor 150. Generally speaking, thin-film transistor 150 includes a plurality of pixel electrodes 152 organized in a series of rows and columns across a surface area of display 118. Each pixel electrode 152 may be selectively energized with electric current so as to induce a local electric field that applies a differential voltage to nearby objects or components. Thin-film transistor 150 may include a plurality of other components (e.g., common electrode(s), polarizer(s), substrate(s), etc.); however, these additional features are not shown in FIG. 3 in the interest of brevity.

Liquid crystal layer 140 includes a plurality of liquid crystal molecules 142. During operations, the differential voltages generated by the local electric fields of selectively energized pixel electrodes 152 cause liquid crystal molecules 142 within liquid crystal layer 140 to assume predetermined orientations. For example, in some instances, when select pixel electrodes 152 are energized, the liquid crystal molecules 142 that are proximate the energized pixel electrodes 152 are oriented so as to allow light to pass through liquid crystal layer 140 at preselected brightness levels. The electrical current provided to the select pixel electrodes 152 may be varied in order to cause a corresponding change in the orientation of the local liquid crystal molecules 142. As a result, an image may be formed by selectively altering the contrast of light that passes through the liquid crystal layer 140.

Referring still to FIG. 3, light that passes through the liquid crystal layer 140 is then directed across color filter 132. Color filter 132 includes a plurality of color filter cells 134 that are each to filter to a specific color of light. For instance, in this example, cells 134 include a repeating pattern of red, blue, and green color filter cells. A grouping of adjacent red, blue, and green color filter cells 134 may be referred to as a pixel—and thus, within each such pixel, the red, blue, and green color filter cells 134 may be referred to as “sub-pixels.” Without being limited to this or any other theory, the color filter cells 134 are to allow light of the corresponding color to pass through and to absorb light of different colors. Thus, the blue color filter cells 134 allow blue colored light to pass through, while absorbing light of other shades. Thus, each red, green, and blue color filter cell 134 may emit red, green, and blue colored light, respectively, and combinations of light from the red, green, and blue color filter cells 134 may be combined to create a multitude of other colors and shades.

In this example, color filter 132 forms an outer surface 118a of display 118 (e.g., similar to outer surface 18a of display 18 in FIGS. 1 and 2). However, in some examples, other layers (e.g., substrates, covers, etc.) may be disposed atop color filter 132 that then forms the outer surface 118a.

Generally speaking, backlight assembly 120 may emit light 126 that is passed through the image generator 110 so as to form images that are viewable on the display 118 by viewers during operations. Backlight assembly 120 includes a plurality of light emitting devices 122 and a light guide 124. The light emitting devices 122 may comprise any device or assembly that may emit light (e.g., white light). For instance, in some examples, light emitting devices 122 are light emitting diodes (LEDs). Light guide 124 may comprise surfaces and/or structures (e.g., reflective surfaces) that are to guide and or direct light 126 that is emitted from the light emitting devices 122 toward outer surface 118a. Specifically, the light guide 124 may direct light emitted from light emitting devices 122 in a direction that is perpendicular or normal to outer surface 118a. Thus, the light 126 emitted from backlight assembly 120 may be collimated light (which is previously described above).

During operations, backlight assembly 120 emits the collimated light 126, which then selectively passes through the liquid crystal layer 140 (e.g., based on the orientation of the liquid crystal molecules 142 as previously described above). Once light 126 is emitted from liquid crystal layer 140, it is passed through color filter 132 so that the black and white image generated by liquid crystal layer 140 may be transformed into a color image. While not specifically shown in the schematic representation of FIG. 3, the color filter cells 134 are generally aligned with the pixel electrodes 152 within thin-film transistor 150. As a result, during operations, pixel electrodes 152 may be energized such that light is allowed to pass through selective color filter cells 134 in selective amounts so that the image generated thereby includes both contrast and color.

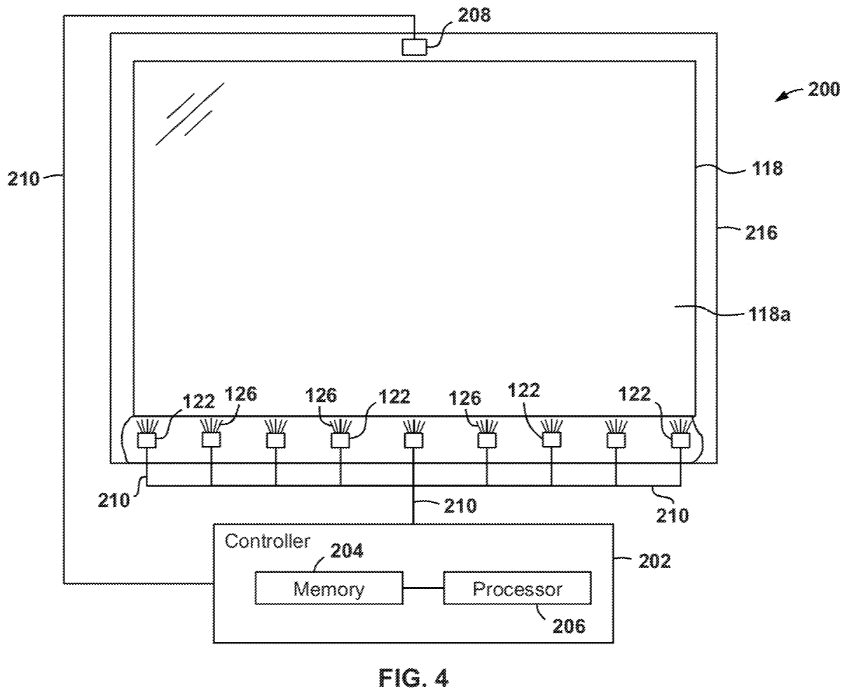

Referring now to FIG. 4, a system 200 for adjusting a backlight assembly of a display based on a position of a viewer according to some examples is shown. In this example, the system 200 includes display 118, which is previously described above (see e.g., FIG. 3). In addition, in this example, the backlight assembly (e.g., backlight assembly 120 in FIG. 3) is an edge type backlight assembly. Thus, light emitting devices 122 are disposed along an edge (e.g., the bottom edge in the example of FIG. 4) of display 118. The light 126 emitted from light emitting devices 122 is generally directed laterally underneath the other layers of display 118, and the light guide (not shown in FIG. 4 but see generally light guide 124 in FIG. 3) redirects the emitted light 126 in a perpendicular or normal direction to outer surface 118a as previously described above. In addition, in this example, the display 118 is supported within a housing 216 (e.g., which may be similar to second housing member 16 previously described above and shown in FIGS. 1 and 2). As shown in FIG. 4, the edge-mounted light emitting devices 122 are disposed under an edge of housing 216, adjacent and along an edge of display 118 (e.g., again the bottom edge in the example of FIG. 4).

In addition, a sensor 208 is mounted within housing 216. In this example, sensor 208 is mounted within housing 216 adjacent a top edge of display 118; however, any suitable placement or arrangement of sensor 208 may be used in other examples. Sensor 208 may detect a position or an indication of a position of a viewer for the display 118. In some examples, sensor 208 may comprise a camera that is to take image(s) of a viewer of display 118 such that a position can be determined therefor. In other examples, different sensing mechanism may be used as sensor 208 (e.g., other than a camera), such as, for instance an infrared (IR) sensor, a ultraviolent (UV) sensor, etc. In some examples, sensor 208 may comprise a plurality of sensors 208 (which may be a plurality of the sensors to measure or detect the same value or a plurality of sensors to measure or detect different values), and the combined output from the plurality of sensors may be used to determine a position of the viewer. As used herein, the position of the viewer may refer to a distance of the viewer from the display 118 as well as a lateral position of the viewer with respect to a center of the display 118.

System 200 further includes a controller 202 coupled to both the sensor 208 and the plurality of light emitting devices 122. Generally speaking, controller 202 receives signals from sensor 208, and selectively adjusts the brightness of the light emitting devices 122 to provide a substantially uniform brightness for display 118 at a determined position of the viewer. That is, the viewer may see a substantially uniform or even brightness (or light level) across an entire surface area of the display 118 from the determined position so that regions or portions of the display 118 that are disposed farther from the viewer (e.g., when the viewer is at the determined position) do not appear to the viewer to be darker than nearer regions or portions of the display 118. Controller 202 may be a dedicated controller for display 118 or may be included within a central controller or control assembly for an electronic device that is coupled to display 118 (e.g., such as electronic device 10). In this example, controller 202 is a dedicated controller for display 118 and is able to communicate with other controllers or control assemblies within an associated or coupled electronic device. The specific components and functions of controller 202 will now be described in detail below.

In particular, controller 202 may comprise any suitable device or assembly which is capable of receiving an electrical or mechanical signal and transmitting various signals to other devices (e.g., sensor 208). In particular, as shown in FIG. 4, in this example, controller 202 includes a processor 206 and a memory 204.

The processor 206 (e.g., microprocessor, central processing unit, or collection of such processor devices, etc.) executes machine-readable instructions (e.g., non-transitory machine readable medium) provided on memory 204, and upon executing the machine-readable instructions on memory 204, provides the controller 202 with all of the functionality described herein. The memory 204 may comprise volatile storage (e.g., random access memory), non-volatile storage (e.g., flash storage), or combinations of both volatile and non-volatile storage. Data consumed or produced by the machine-readable instructions can also be stored on memory 204.

Controller 202 is coupled or linked to sensor 208 and light emitting devices 122 by a plurality of conductive paths 210, which may comprise any suitable wired and/or wireless conductive path for transferring power and/or control signals (e.g., electrical signals, light signals, etc.). For example, in some implementations, conductive paths 210 may comprise conductive wires (e.g., metallic wires), fiber optic cables, conductive leads, etc. In other implementations, conductive paths 210 may comprise wireless connections (e.g., WI-FI, BLUETOOTH®, near field communication, infrared, radio frequency communication, etc.).

During operations, controller 202 receives an output signal from sensor 208. The output from sensor 208 may provide a position of a viewer viewing the display 118 or may include an indication of the position of display 118. As a result, in some examples, controller 202 may determine (e.g., via processor 206 executing machine readable instructions stored in memory 204) the position of a viewer relative to display 118 (including a distance and viewing angle relative to the light emitting devices 122 as described in more detail below) based on the output from sensor 208. Once a position of a viewer is determined, controller 202 may then adjust a brightness of light emitted from different portions of backlight assembly (e.g., backlight assembly 120 shown in FIG. 3) such that the viewer may see a substantially uniform brightness across the width or span of the display 118. In particular, as is explained in more detail below, controller 202 may adjust a brightness of one, or a plurality of, the light emitting devices 122 relative to the other light emitting devices 122 in display 118 based on the determined position of the viewer.

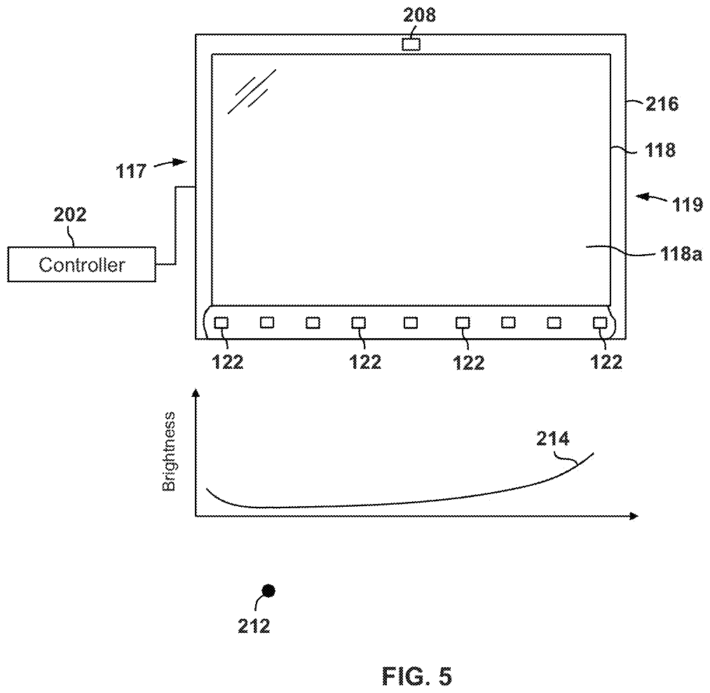

Referring now to FIG. 5, a viewer of the display 118 may shift or move to a position 212 that is closer to a first or left side 117 of the display 118 than a second or right side 119 of the display 118. Accordingly, the controller 202 may determine, via the sensor 208, that the viewer has moved to the position 212. For instance, as previously described above, in some examples, sensor 208 may take an image of the viewer (e.g., for examples wherein sensor 208 is a camera), and this image may be utilized by controller 202 (either alone or in addition to other data) to determine that viewer is in the position 212.

Thereafter, controller 202 may adjust a brightness of the light emitting devices 122 based on the determined position 212 of the viewer such that the viewer sees a uniform brightness across the entire lateral span of display 118 (e.g., between left and right sides 117, 119). Specifically, controller 202 may determine a distance of position 212 from the display 118 (e.g., a perpendicular distance from outer surface 118a or a projection thereof), and a viewing angle of position 212 to each light emitting device 122. As used herein, the viewing angle of the position of the viewer (e.g., position 212) relative to a light emitting device 122 (or portion of the backlight assembly) may refer to an angle of the line of sight for the position 212 to an axis extending perpendicularly outward from the light emitting device 122. The distance and viewing angles of the position may be determined based on the output from sensor 208. For instance, the output from sensor 208 may directly inform or measure the distance and/or viewing angles of the position 212 relative to light emitting devices 122 or controller 202 may perform additional processing, calculations, and/or actions to determine the distance and/or viewing angles based (wholly or partially) on the output from sensor 208.

Without being limited to this or any other theory, as the viewer's viewing angle to a particular light emitting device 122 increases, the brightness perceived by the viewer from that light emitting device 122 decreases. Thus, as a viewing angle of the viewer relative to a particular light emitting device 122 increases, the viewer generally sees a relatively dimmer light. Therefore, during operations, controller 202 may adjust a brightness of the light emitting devices 122 based on the determined viewing angle of the viewer's position 212 to each light emitting device 122. Specifically, the brightness of the light emitting devices 122 with the smallest corresponding viewing angles may be decreased to a relative minimum to the other light emitting devices 122 within display 118, and the light emitting devices 122 with the largest corresponding viewing angles maybe increase to a maximum compared to the brightness of the other light emitting devices 122 within display 118. Between these relative maximum and minimum brightness values, the controller 202 may adjust the brightness of all of the light emitting devices 122 so as to form a smooth brightness curve or profile 214 across the span of the display 118.

Because the position 212 of the viewer is shifted to the left side 117 of display 118 in FIG. 5, the portion of the light emitting devices 122 toward the left side 117 of display 118 are adjusted by controller 202 to be generally less bright than the light emitting devices 122 toward the right side 119 of display 118. This relative slope or change in the brightness of light emitting devices 122 may be seen or appreciated from the brightness curve 214. However, because the light emitted from outer surface 118a of display 118 is collimated (e.g., such as discussed above for light 126 in FIG. 3), the viewer may see a substantially uniform brightness from the display 118 across the entire width or span thereof at the position 212.

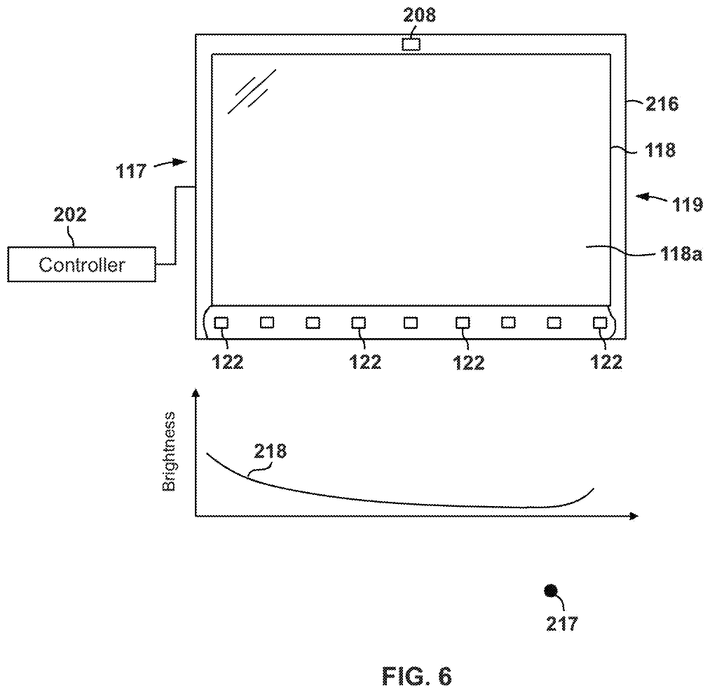

Referring now to FIG. 6, in this example, the viewer has shifted to a position 217 that is closer to the right side 119 of display 118 than left side 117 of display 118. As a result, controller 202 may determine, via sensor 208, the position 217 of the viewer, and then adjust the relative brightness of the light emitting devices 122 based on a corresponding viewing angle to the viewer's position 217 from each light emitting device 122 in the manner described above. Because the position 217 of the viewer is shifted to the right side 119 of display 118 in FIG. 6, the portion of the light emitting devices 122 toward the right side 119 of display 118 are adjusted by controller 202 to be generally less bright than the light emitting devices 122 toward the left side 117 of display 118, and this relative slope or change in the brightness of light emitting devices 122 may be seen or appreciated from the brightness curve 218. However, as previously described above, because the light emitted from outer surface 118a of display 118 is collimated (e.g., such as discussed above for light 126 in FIG. 3), the viewer may see a substantially uniform brightness from the display 118 across the entire width or span thereof at the position 217.

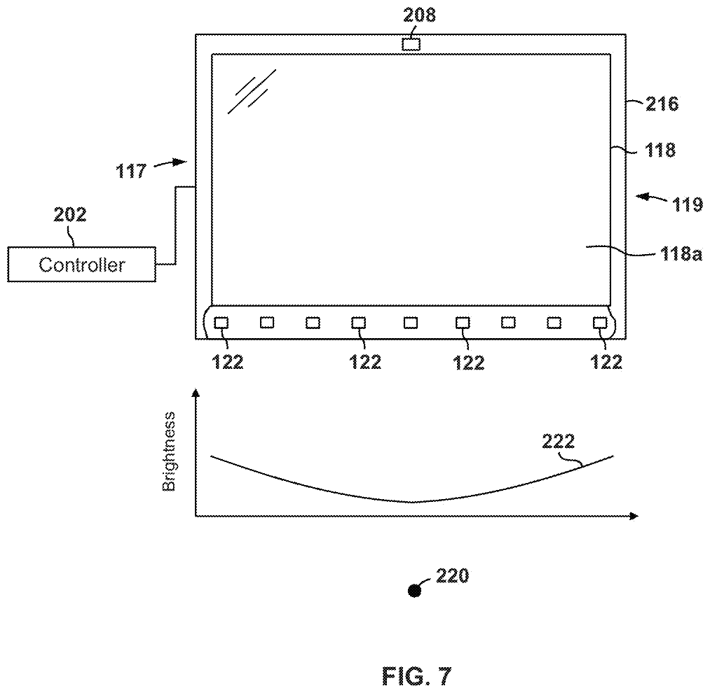

Referring now to FIG. 7, in this example, the viewer has shifted to a position 220 that is generally equidistant between the left side 117 and right side 119 of display 118. As a result, controller 202 may determine, via sensor 208, the position 220 of the viewer, and then adjust the relative brightness of the light emitting devices 122 based on a corresponding viewing angle to the viewer's position 220 from each light emitting device 122 in the manner described above. Because the position 220 of the viewer is substantially equally disposed between left side 117 and right side 119 of display 118 in FIG. 7, the portion of the light emitting devices 122 toward the center region of display 118 are adjusted by controller 202 to be generally less bright than the light emitting devices 122 toward the left side 117 and right side 119 of display 118, and this relative slope or change in the brightness of light emitting devices 122 may be seen or appreciated from the brightness curve 222. However, as previously described above, because the light emitted from outer surface 118a of display 118 is collimated (e.g., such as discussed above for light 126 in FIG. 3), the viewer may see a substantially uniform brightness from the display 118 across the entire width or span thereof at the position 220.

Thus, by detecting or monitoring a position of the viewer, the controller 202 may make adjustments to the relative brightness across the light emitting devices 122 of display 118 so as to ensure that the viewer may see a substantially uniform brightness across the span of the display 118 during operations. Thus, for displays that emit collimated light (e.g., such as light 126 shown in FIG. 3 and discussed above), the viewer may more easily view all portions of the display 118 regardless of their position relative thereto.

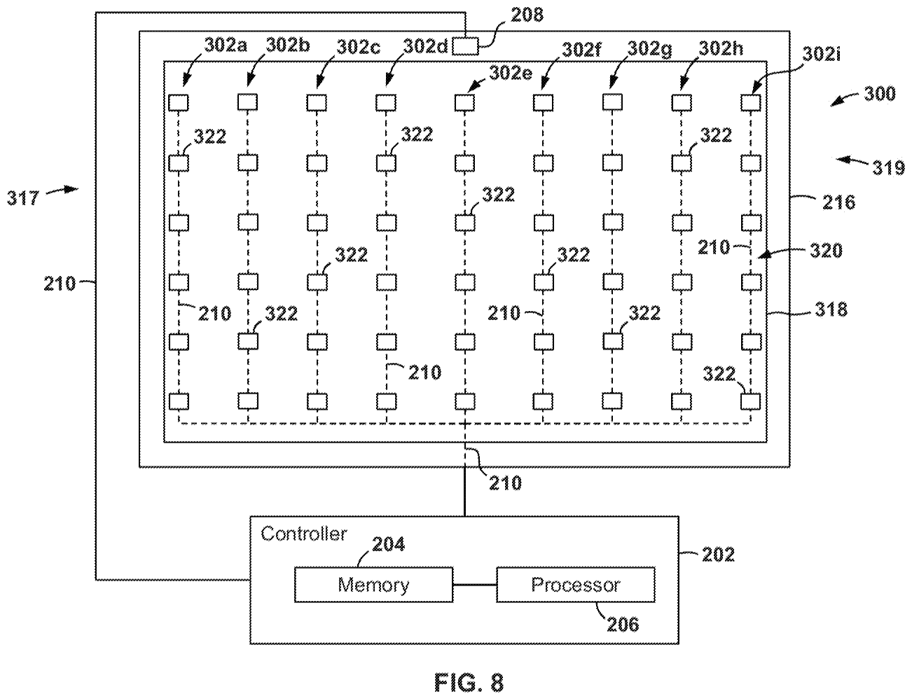

Referring now to FIG. 8, another system 300 for adjusting a backlight assembly of a display based on a position of a viewer according to some examples is shown. System 300 shares many components and features with system 200, previously described, and thus, the features of system 300 that are shared with system 200 are identified with the same reference numerals and the discussion below will focus on the features of system 300 that are different from the features of system 200. In general, system 300 includes a display 318 and sensor 208 mounted within housing 216 as generally described above for system 200. In addition, system 300 includes a controller 202 coupled to sensor 208 and display 318.

Display 318 includes generally the same features described above for display 118 (see e.g., FIGS. 3 and 4); however, display 318 includes a backlight assembly 320 in place of backlight assembly 120 of display 118. In particular, backlight assembly 320 includes a plurality of so-called direct light emitting devices 322 disposed directly below the other layers or components of display 318 (e.g., color filter 132, liquid crystal layer 140, thin-film transistor 150, etc.) in place of the edge-mounted light emitting devices 122. While not specifically shown, display 318 may also include a light guide (see e.g., light guide 124) to direct or guide light emitting from the light emitting devices 322 in a perpendicular direction relative to an outer surface 318a of display 318 (i.e., such that the light is collimated as previously described above). The light emitting devices 322 may also comprise any of the light emitting devices described above for the light emitting devices 122 (e.g., such as LEDs).

As shown in FIG. 8, the light emitting devices 322 are arranged into a plurality of columns 302a-i that are spaced laterally across the display 318 from a first or left side 317 to a second or right side 319. The light emitting devices 322 are coupled to controller 202 via plurality of conductive paths 210 (which are previously described above).

During operations, controller 202 may determine a position of a viewer relative to display 318 via sensor 208 and then may adjust the relative brightness of portions of backlight assembly 320 such that the viewer may see a substantially uniform brightness across the display 318 at the determined position as previously described above for system 200. However, in this example, controller 202 may adjust a brightness of each column 302a-i of light emitting devices 322 relative to the other columns 302a-i. Specifically, controller 202 may determine a distance and viewing angle of the viewer (at the determined position) relative to the light emitting devices 322 in each column 302a-i. In some examples, controller 202 may determine the distance and/or viewing angle to the columns 302a-i of light emitting devices 322 based wholly or partially on the output from sensor 208 as previously described above for system 200. The viewing angle may be the same for each light emitting device 322 of a given column 302a-i. Then the controller may adjust a brightness of the light emitting devices 322 of a given column 302a-i relative to the light emitting devices 322 of the other columns 302a-i, based on the determined viewing angles as generally described above for system 200. As a result, the viewer may see a substantially uniform brightness across the width or span of the display regardless of the position of the viewer relative to the display.

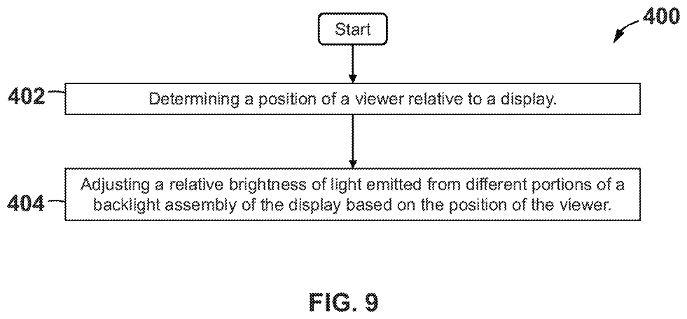

Referring now to FIG. 9, a method 400 of adjusting a backlight assembly of a display based on a position of a viewer is shown. Method 400 may be practiced utilizing the systems 200, 300 described above, or may be practiced with systems that are different from systems 200, 300. Generally speaking, method 400 includes determining a position of a viewer relative to a display at 402. Determining a position of a viewer relative to a display may comprise detecting a position (or an indication of the position) of the viewer with a sensor (e.g., such as sensor 208 previously described above). In addition, in some examples, determining the position of the viewer at 402 may comprise capturing an image (or a plurality of images) with a camera and analyzing the captured image with a processor of a location identifying module (e.g., processor 206 in controller 202). In some examples, the location identifying module may employ facial recognition technology. In addition, the location identifying module may determine a location of viewer relative to a surface area of the display. For instance, the determined location of the viewer may be characterized as a position relative to and along a pair of orthogonal axes extending across the surface of the display (e.g., such as horizontal and vertical axes).

In addition, method 400 includes adjusting a relative brightness of light emitted from different portions of a backlight assembly of the display based on the position of the viewer at 404. In some examples, adjusting a relative brightness of light emitted from different portions of a backlight assembly may comprise adjusting a relative brightness of different light emitting devices (e.g., light emitting devices 122, 322, etc.) of a backlight assembly (e.g., backlight assemblies 120, 320, etc.) based on the determined position of the viewer. In some examples, adjusting a relative brightness of light emitted from different portions of the backlight assembly may comprise adjusting a set or group of light emitting devices (e.g., column 302a, 302b, 302c, 302d, 302e, 302f, 302g, 302h, 302i, etc.) relative to another set or group of light emitting devices within the backlight assembly. In addition, in some examples, the adjusting at 404 may comprise adjusting the relative brightness of different portions of a backlight assembly such that the viewer may see or discern a substantially uniform brightness across the width or span of the display at the determined position. As previously described above, the adjusting at 404 may comprise adjusting the light emitted from the light emitting devices of a backlight assembly (e.g., light emitting devices 122, 322, etc.) based on a distance and/or viewing angle of the viewer to the light emitting devices. For instance, in some examples, an increasing viewing angle to a particular light emitting device or group thereof may result in an increasing brightness for the corresponding light emitting devices, and a decreasing viewing angle to a particular light emitting device or group thereof may result in a decreasing brightness for the corresponding light emitting devices.

Thus, the systems (and associated methods) described herein may cause a brightness of an electronic display (e.g., displays 18, 118, 318, etc.) to be adjusted based on a determined position of the viewer relative to the display so as to provide the viewer with a substantially uniform brightness across the display during operations. Accordingly, through use of the examples disclosed herein, a viewer may perceive all portions of a display emitting collimated light regardless of their position relative thereto.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A system, comprising:
a display comprising:
an outer surface; and
a backlight assembly comprising:
a plurality of light emitting devices; and
a light guide to direct light from the plurality of light emitting devices in a direction that is perpendicular to the outer surface; and
a controller coupled to the backlight assembly, the controller to adjust a brightness of a first of the plurality of light emitting devices relative to a brightness of second of the plurality of light emitting devices based on a position of the viewer relative to the display, such that the brightness of the first of the plurality of light emitting devices and the brightness of the second of the plurality of light emitting devices is substantially uniform from the position of the viewer.

2. The system of claim 1, wherein the controller is to:
determine a viewing angle for the position of the viewer for each light emitting device;
adjust the brightness of some of the light emitting device based on the viewing angle.

3. The system of claim 1, wherein the plurality of light emitting devices are disposed along an edge of the display.

4. The system of claim 3, comprising a sensor, wherein the controller is to determine the position of the viewer via the sensor.

5. The system of claim 1, wherein the plurality of light emitting devices comprises a first set of light emitting devices and a second set of light emitting devices, and
wherein the controller is to increase a brightness of the second set of light emitting devices relative to a brightness of the first set of light emitting devices, when the first set of light emitting devices is disposed closer to the position of the viewer than the second set of light emitting devices.

6. A system, comprising:
a display comprising:
an outer surface; and
a backlight assembly to emit light in a direction that is perpendicular to the outer surface; and
a controller coupled to the backlight, the controller to adjust a brightness of light emitted from a first portion of the backlight assembly relative to a brightness of light emitted from a second portion of the backlight assembly to provide a substantially uniform brightness for the display at a position of the viewer relative to the display.

7. The system of claim 6, wherein the controller is to increase the brightness of light emitted from the second portion relative to the brightness of light emitted from the first portion when the first portion is located closer to the position of the viewer than the second portion.

8. The system of claim 6, wherein the backlight assembly comprises a plurality of light emitting devices;
wherein the controller is to:
determine a viewing angle for each light emitting device at the position of the viewer; and
adjust the brightness of some of the light emitting device based on the viewing angle.

9. The system of claim 6, comprising a sensor, wherein the controller is to determine the position of the viewer via the sensor.

10. A method, comprising:
determining a position of a viewer relative to a display; and
adjusting a relative brightness of light emitted from different portions of a backlight assembly of the display based on the position of the viewer.

11. The method of claim 10, comprising:
determining that a first portion of the backlight assembly is closer to the position of the viewer than a second position of the backlight assembly;
wherein adjusting the brightness of light emitted from different portions of a backlight assembly comprises increasing a brightness of light emitted from the second portion relative to a brightness of light emitted from the first portion.

12. The method of claim 10, wherein the backlight assembly comprises a plurality of light emitting devices;
wherein method comprises determining a viewing angle for each light emitting device at the position of the viewer; and
wherein adjusting a relative brightness of light emitted from different portions of a backlight assembly comprises adjusting a brightness of light emitted from some of the light emitting devices based on the viewing angle.

13. The method of claim 12, wherein the plurality of light emitting devices are disposed along an edge of the display.

14. The method of claim 10, comprising providing a substantially uniform brightness across the display at the position of the viewer as a result of the adjusting.

15. The method of claim 10, comprising directing light perpendicularly from an outer surface of the display with the backlight assembly.
